(19) United States
(12) Patent Application Publication
(10) Pub. No.: US 2020/0403775 A1
(43) Pub. Date: Dec. 24, 2020

(54) UNIVERSAL ELECTRONIC DOCUMENT VERIFICATION SYSTEM AND METHOD WITH BLOCKCHAIN

(71) Applicants: Chih-Kang Huang, New Taipei City (TW); Chih-Hsiang Hwang, Taichung City (TW)

(72) Inventors: Chih-Kang Huang, New Taipei City (TW); Chih-Hsiang Hwang, Taichung City (TW)

(21) Appl. No.: 16/857,109

(22) Filed: Apr. 23, 2020

(30) Foreign Application Priority Data
Jun. 20, 2019 (TW) 108207892

(51) Int. Cl. H04L 9/06; H04L 9/08; G06F 16/93; G06F 16/23; G06F 21/60

(52) U.S. Cl. CPC H04L 9/0637; H04L 9/0866; H04L 9/0643; H04L 2209/38; G06F 16/2379; G06F 21/602; G06F 16/93

(57) ABSTRACT

A universal electronic document verification system with blockchain includes a management interface, configured to connect at least a blockchain; a document deposit terminal, configured to generate a private key and a blockchain account corresponding to the private key, configured to make public an identification (ID) account having the blockchain account and an ID information of document deposit terminal corresponding to the blockchain account, and to generate an original document hash value according to a specific hash function and an electronic document, so as to generate an issued document according to the private key and the original document hash value; and a document verification terminal, configured to receive the electronic document and the corresponding blockchain transaction number to generate a to-be-checked document hash value according to the specific hash function and the electronic document and to submit the blockchain transaction number to the management interface.

### CROSS REFERENCE TO RELATED APPLICATION

This application claims the benefit of Taiwan Application No. TW108207892 filed on 2019 Jun. 20, the contents of which are incorporated herein in their entirety.

### BACKGROUND OF THE INVENTION

### 1. Field of the Invention

The present invention relates to a universal electronic document verification system and method with blockchain, and more particularly, to a universal electronic document verification system and method with blockchain capable of avoiding leaking personal information and verifying authenticity of electronic document and an identification of an issuer by looking up blockchain of the issuer of the electronic document.

### 2. Description of the Prior Art

In general, electronic documents are easy to be replicated or tampered and are hard to confirm an identification of a document issuer, such that public documents, e.g. graduation certification, professional license, contract or visa, are printed on paper with stamp for recipients or both parties. However, papers are costly and cannot be transmitted as timely as the electronic documents. In addition, when a third party asks for verification, publications cannot reveal personal information of the recipient because of personal information protections, which make events of certification counterfeits to repeatedly occur. For example, after a certification of a graduate is granted by a school organization and the certification is provided to a company for an interview, the company cannot verify an authenticity of the certification, and the school organization cannot reveal the authenticity because of the personal information regulations when the company directly asks the school organization.

Therefore, a technology for verifying the authenticity of certification with blockchain technique is proposed by the school organization, which belongs to a dedicated close system and is not accessible by other units, since credibility is missing if the verification is performed by other units. For example, a blockchain certification system of Massachusetts Institute of Technology (MIT) can only verify degree certifications of MIT and cannot verify degree certifications of University of Southern California, since the degree certifications of University of Southern California are not issued by MIT, which lacks credibility. Since a verification system of one university may only verify its graduation certifications, a verification system of third-party verification system is needed to verify graduation certifications from different organizations. In addition, a verification system of an education bureau of a county, a ministry of education of a country may respectively verify certifications or licenses issued from themselves, and cannot be universal to other units from other counties, countries or organizations, which increases consumptions of resources. Moreover, a blockchain transaction number is necessary for a conventional blockchain technique, e.g., no blockchain data will be found when only an electronic document is submitted, and the blockchain transaction number is suffered from risks of being lost. That is, the verification cannot be performed with only the electronic document.

Referring to an electronic document with multiple issuers of the conventional technique, multiple blockchain transaction numbers are needed to look up multiple issuers one by one, which is not effective. For example, a group buying contract promises to deduct 5,000 United States dollars (USD) for each item when ten people place orders within a specific period. However, when one of them does not submit the blockchain transaction number and the group buying contract is cancelled, which might generate disputes.

Therefore, how to solve the above problems is an important issue in the industry.

### SUMMARY OF THE INVENTION

The present invention provides a universal electronic document verification system and method with blockchain, which avoids leaking personal information and verifies authenticity of electronic document and an identification of an issuer by looking up blockchain of the issuer of the electronic document.

An embodiment of the present invention discloses a universal electronic document verification system with blockchain, comprises a management interface, configured to connect at least a blockchain; a document deposit terminal, configured to generate a private key and a blockchain account corresponding to the private key, configured to make public an identification (ID) account having the blockchain account and an ID information of document deposit terminal corresponding to the blockchain account, and to generate an original document hash value according to a specific hash function and an electronic document, so as to generate an issued document according to the private key and the original document hash value, wherein the issued document is written into a blockchain of the at least a blockchain to record the original document hash value, the blockchain account and a written time-stamp to generate a corresponding blockchain transaction number; and a document verification terminal, configured to receive the electronic document and the corresponding blockchain transaction number to generate a to-be-checked document hash value according to the specific hash function and the electronic document and to submit the blockchain transaction number to the management interface; wherein the management interface is configured to obtain and submit the original document hash value and the blockchain account from the blockchain to the document verification terminal for verifying the to-be-checked document hash value with the original document hash value recorded in the blockchain and determining the blockchain account and the ID account.

Another embodiment of the present invention discloses a universal electronic document verification method with block chain, comprises connecting at least a blockchain of a management interface; generating a private key and a blockchain account corresponding to the private key, and making public an identification (ID) account having the blockchain account and an ID information of a document deposit terminal corresponding to the blockchain account; generating an original document hash value according to a specific hash function and an electronic document, so as to generate an issued document according to the private key and the original document hash value, wherein the issued document is written into a blockchain of the at least a blockchain to record the original document hash value, the blockchain account and a written time-stamp to generate a corresponding blockchain transaction number; receiving the electronic document and the corresponding blockchain transaction number, by a document verification terminal, to generate a to-be-checked document hash value according to the specific hash function and the electronic document and to submit the blockchain transaction number to the management interface; and obtaining and submitting the original document hash value and the blockchain account from the blockchain, by the management interface, to the document verification terminal for verifying the to-be-checked document hash value with the original document hash value recorded in the blockchain and determining the blockchain account and the ID account.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a universal electronic document verification system according to an embodiment of the present invention.

FIG. 2 is a schematic diagram of a universal electronic document verification system according to another embodiment of the present invention.

FIG. 3 is a schematic diagram of a universal electronic document verification process according to an embodiment of the present invention.

FIG. 4 is a schematic diagram of a universal electronic document verification process according to another embodiment of the present invention.

### DETAILED DESCRIPTION

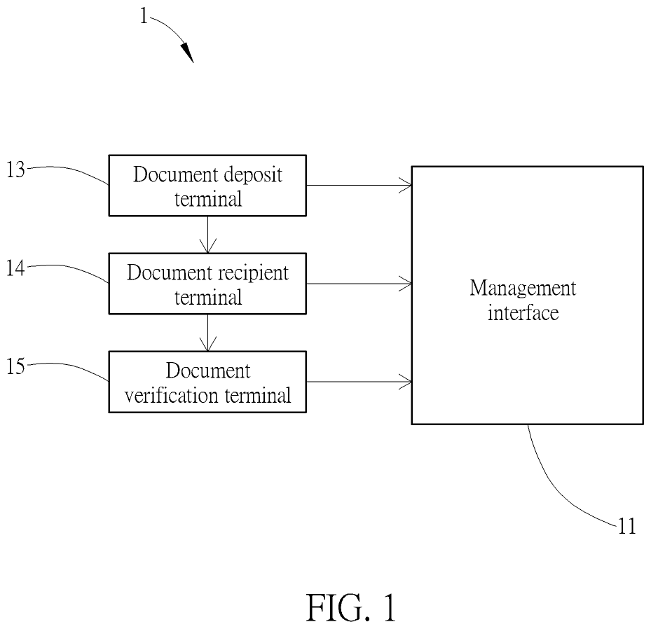

Please refer to FIG. 1, which is a schematic diagram of a universal electronic document verification system 1 according to an embodiment of the present invention. The universal electronic document verification system 1 includes a management interface 11, a document deposit terminal 13, a document recipient 14 and a document verification terminal 15, wherein the document deposit terminal 13 may be a school organization, the document recipient 14 may be a graduate of the school organization, and the document verification terminal 15 may be an interview department of a company. That is, the school organization provides a graduation certification to the graduate and the graduate provides the graduation certification to the interview department of the company, and then the interview department of the company thereby verifies an authenticity of the graduation certification. In an alternatively embodiment, the document deposit terminal 13 may be a person or a company, the document verification terminal 15 may be a bank, and the person or the company asks for loans from the bank. A contract or multi-party contract of the person or the company is necessary for the bank to guarantee a loan repayment capacity, and the bank may verify authenticity of the contract or the multi-party contract provided by the person or the company.

The management interface 11 is configured to connect at least a blockchain, and the document deposit terminal 13 is configured to generate a private key and a blockchain account corresponding to the private key by a blockchain account generator, and the document deposit terminal 13 is configured to make public an identification (ID) account having the blockchain account and an ID information of document deposit terminal 13 corresponding to the blockchain account.

The document deposit terminal 13 may make public of the ID account via the Internet, which may be an official website or a governmental website, a guild website or a third party impartial unit website. Or, the document deposit terminal 13 may provide the blockchain account, the ID information to the management interface or a third-party verification website or a governmental website, which belong to the scope of being public.

In addition, the ID information of the document deposit terminal may be the information itself, e.g. a school, a company, a layer, a person or general information (e.g. a uniform business number or a certification number), and the ID account is a combination of the blockchain account and the ID information, i.e. the blockchain account with the ID information. For example, Harvard University may make public of its blockchain account with ID information on the official website of Harvard University. After the ID account is made public, the document verification terminal 15 may directly determine the ID information and corresponding blockchain account of the document deposit terminal 13.

In an embodiment, the document deposit terminal 13 is configured to generate an original document hash value according to a specific hash function and the electronic document, such that the document deposit terminal 13 may generate an issued document according to the private key and the original document hash value. Then, the document deposit terminal 13 writes the issued document into blockchain of the at least a blockchain to record the original document hash value, the blockchain account and a written time-stamp to generate a corresponding blockchain transaction number.

Then, the document deposit terminal 13 may transmit the electronic document and the blockchain transaction number to the document recipient terminal 14, and then the document recipient terminal 14 transmits the electronic document and the blockchain transaction number to the document verification terminal 15. After the document verification terminal 15 receives the electronic document and the blockchain transaction number, the document verification terminal 15 is configured to generate a to-be-checked document hash value according to the specific hash function of the electronic document, and to submit the blockchain transaction number to the management interface 11. The management interface 11 obtains the blockchain record according to blockchain transaction number and receives the original document hash value and the blockchain account corresponding to the blockchain and provides the original document hash value and the blockchain account to the document verification terminal 15. Then, the document verification terminal 15 is configured to compare the to-be-checked document hash value and the original document hash value. If the to-be-checked document hash value is identical to the original document hash value, the electronic document provided by the document recipient terminal 14 is identical to an original document of the document deposit terminal 13, i.e. the original document is not tampered.

The ways how the document verification terminal 15 verifies the ID of the document deposit terminal 13 areas follows. In an example, if the to-be-checked document hash value is identical to the original document hash value, the document verification terminal 15 compares the blockchain account and the ID account. When the two above verifications are identical, the identity of document deposit terminal 13 may be confirmed. Therefore, an independent electronic document verification system is not necessary to the document deposit terminal 13 for storing blockchains, which avoids leaking personal information. The document verification terminal 15 compares whether the electronic document is identical to the electronic document of the document deposit terminal 13 to verify the ID of the document deposit terminal 13. In addition, the management interface 11 is configured to bind the data to the account to increase a speed of comparison, which is more economic, avoids leaking personal information, is of higher credibility and more efficient than the prior arts.

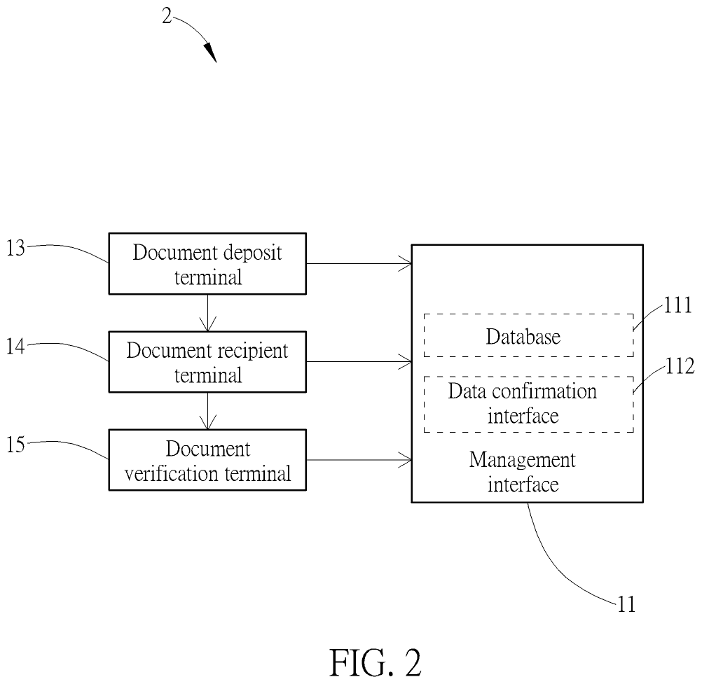

Please refer to FIG. 2, which is a schematic diagram of a universal electronic document verification system 2 according to an embodiment of the present invention. As shown in FIG. 2, the universal electronic document verification system 2 includes the management interface 11, the document deposit terminal 13, the document recipient terminal 14 and the document verification terminal 15. The document deposit terminal 13 is configured to generate an original document hash value according to a specific hash function and an electronic document. The document deposit terminal 13 generates an issued document according to the private key and the original document hash value. Then, the document deposit terminal 13 transmits the issued document to the blockchain via the management interface 11, wherein the blockchain records the original document hash value, the blockchain account, the written time-stamp to generate a corresponding blockchain transaction number. In addition, the management interface 11 binds the original document hash value to the blockchain transaction number, which is stored in a database 111.

The document deposit terminal 13 may transmit the electronic document to the document recipient terminal 14, and the document recipient terminal 14 may transmit the electronic document to the document verification terminal 15. After the document verification terminal 15 is configured to receive the electronic document, the document verification terminal 15 is configured to generate a to-be-checked document hash value according to the electronic document and the specific hash function. Notably, the specific hash function utilized by the document deposit terminal 13 is identical to the document verification terminal 15. The document verification terminal 15 is configured to submit the to-be-checked document hash value to the management interface 11. The management interface 11 is configured to obtain the blockchain transaction number, which is bond to the original document hash value from the database 111. The management interface 11 is configured to obtain the original document hash value and the blockchain account based on the blockchain transaction number corresponding to the blockchain and then submit the original document hash value and the blockchain account to the document verification terminal 15. The document verification terminal 15 is configured to compare the to-be-checked document hash value and the original document hash value, if the to-be-checked document hash value is identical to the original document hash value, which represents that the electronic document provided by the document recipient terminal 14 matches with an original document of the document deposit terminal 13, and the electronic document is not tampered.

The ways to verify the ID of document deposit terminal 13 are as follows. In an example, when the to-be-checked document hash value is identical to the original document hash value, the document verification terminal 15 compares the blockchain account and the ID account, and then verifies the ID of the document deposit terminal 13. In another example, the document deposit terminal 13 may provide the blockchain account and the ID information of the document deposit terminal to the management interface 11, the management interface 11 is configured to bind the ID information of the document deposit terminal to the blockchain account as the ID account and then store the ID account. In addition, the management interface 11 may further include a data confirmation interface 112. In an embodiment, when the to-be-checked document hash value is identical to the original document hash value, the document verification terminal 15 may input the blockchain account or simultaneously input the blockchain account and the ID information of the document deposit terminal into the data confirmation interface 112, such that the management interface 11 may compare the ID account to verify the ID of the document deposit terminal 13. For example, the document verification terminal 15 receives an electronic degree certification of “A” University from a graduate, if a hash value and an original document hash value of corresponding blockchain of the electronic degree certification are identical, the electronic degree certification is not tampered. And the document verification terminal 15 may look up the public blockchain account on the official website of the “A” University, and the degree certification is acknowledged as authentic when the comparison result is consistent. In an alternative embodiment, a tenant receives an electronic lease contract from a house landlord, if a hash value of the electronic lease contract is identical to an original document hash value of corresponding blockchain record, the ID information of the blockchain account is replied when the tenant inputs the blockchain account corresponding to the blockchain record into a confirmation interface. In another embodiment, the tenant may input the blockchain account corresponding to the blockchain record and an ID number of the house landlord for verification. As such, a verification system for electronic documents is not necessary to the document deposit terminal 13 to avoid leaking personal information and to provide the blockchain to the document verification terminal 15 for verifying whether the electronic document of the document deposit terminal 13 is identical to the original document and verifying the ID of the document deposit terminal 13. In addition, the management interface 11 may further bind the data to the account to increase a speed of comparison, which is more economic, avoids leaking personal information, is of higher credibility and more efficient than the prior arts.

Since multiple document deposit terminals 13 are configured to generate corresponding original document hash values, which are issued and written into blockchains, multiple blockchain transaction numbers are generated. As such, the management interface 11 binds the original document hash value and the blockchain transaction number to accelerate a verification speed, and the management interface 11 may obtain multiple blockchain transaction numbers according to the multiple original document hash values, and then the management interface 11 may obtain corresponding blockchain accounts, the written time-stamps and the original document hash values from the blockchain accordingly. Therefore, the management interface 11 of the present invention binds the original document hash value to the corresponding blockchain transaction number to accelerate the comparison speed and confirm all of the document deposit terminals 13.

In an embodiment, the management interface is configured to compare the blockchain account and the ID account of the document deposit terminal 13 to determine a comparison result and provide the comparison result to the document verification terminal 15. In another embodiment, the management interface 11 may receive the electronic document and then provide the electronic document to the document verification terminal 15, such that the management interface 11 may directly find out the to-be-checked document hash value by the specific hash function, and obtain the original blockchain transaction number. Then, the management interface 11 may provide the original document hash value, which is obtained from the blockchain record, and the blockchain account of the issuer to the document verification terminal 15. For example, a graduate may provide his/her electrical graduate certification to the management interface 11 in advance, such that the interview department of a company may directly obtain and verify the graduate certification from the management interface 11 with authenticity. Furthermore, the management interface 11 may monitor the ID account and trigger a warning when the ID account is modified. For example, if a hacker tampered the ID account of the document deposit terminal 13, the management interface 11 may automatically warn the corresponding document verification terminal.

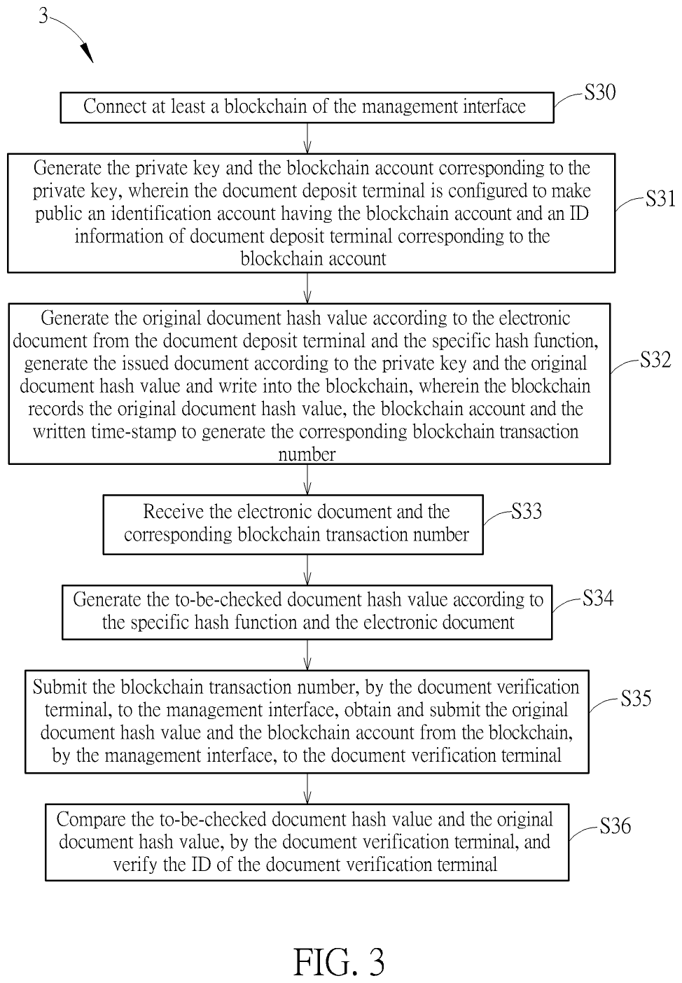

Please refer to FIG. 3, which is a schematic diagram of a universal electronic document verification process 3 of FIG. 1 according to an embodiment of the present invention. The universal electronic document verification process 3 includes the following steps:

Step S30: Connect at least a blockchain of the management interface 11.

Step S31: Generate the private key and the blockchain account corresponding to the private key, wherein the document deposit terminal 13 is configured to make public an identification (ID) account having the blockchain account and an ID information of document deposit terminal 13 corresponding to the blockchain account.

Step S32: Generate the original document hash value according to the electronic document from the document deposit terminal 13 and the specific hash function, generate the issued document according to the private key and the original document hash value and write into the blockchain, wherein the blockchain records the original document hash value, the blockchain account and the written time-stamp to generate the corresponding blockchain transaction number.

Step S33: Receive the electronic document and the corresponding blockchain transaction number.

Step S34: Generate the to-be-checked document hash value according to the specific hash function and the electronic document.

Step S35: Submit the blockchain transaction number, by the document verification terminal 15, to the management interface 11, obtain and submit the original document hash value and the blockchain account from the blockchain, by the management interface 11, to the document verification terminal 15.

Step S36: Compare the to-be-checked document hash value and the original document hash value, by the document verification terminal 15, and verify the ID of the document verification terminal 15.

When the to-be-checked document hash value is identical to the original document hash value, the electronic document provided by the document recipient terminal 14 is identical to the original document of the document deposit terminal 13. When the to-be-checked document hash value is identical to the original document hash value, the document verification terminal 15 compares the blockchain account and the ID account. Therefore, an electronic document verification system is not necessary to the document deposit terminal 13 for storing blockchains, which avoids leaking of personal information. The document verification terminal 15 compares whether the electronic document is identical to the electronic document of the document deposit terminal 13 to verify the ID of the document deposit terminal 13. In addition, the management interface 11 is configured to bind the data to the account to increase a speed of comparison, which is more economic, avoids leaking personal information, is of higher credibility and more efficient than the prior arts.

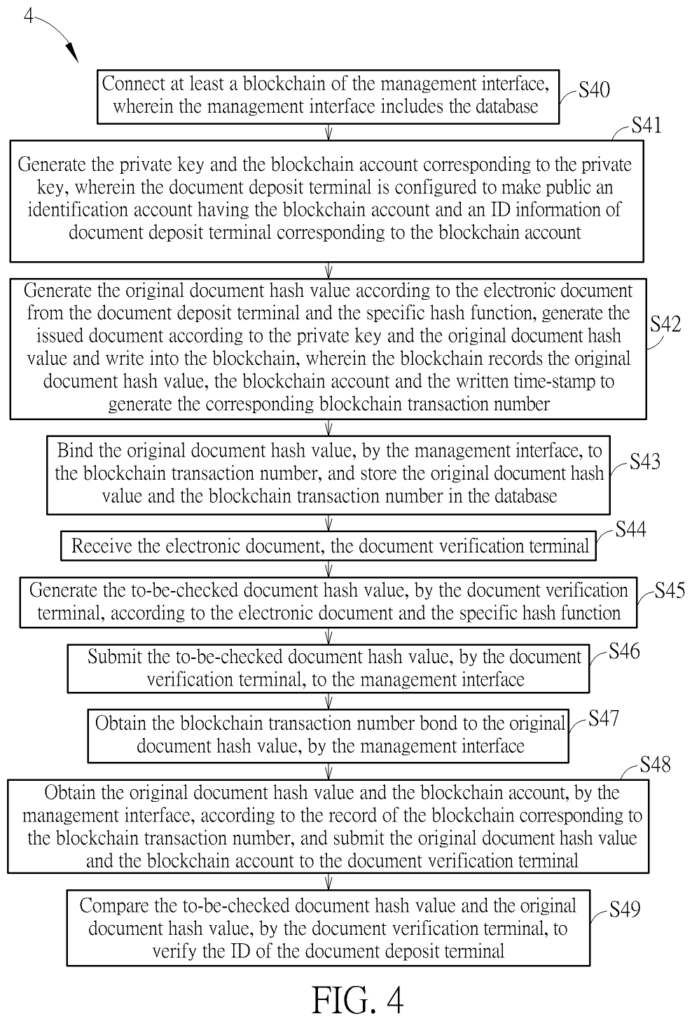

Please refer to FIG. 4, which is a schematic diagram of a universal electronic document verification process 4 of FIG. 2 according to an embodiment of the present invention. The universal electronic document verification process 4 includes the following steps:

Step S40: Connect at least a blockchain of the management interface 11, wherein the management interface includes the database 111.

Step S41: Generate the private key and the blockchain account corresponding to the private key, wherein the document deposit terminal 13 is configured to make public an identification (ID) account having the blockchain account and an ID information of document deposit terminal 13 corresponding to the blockchain account.

Step S42: Generate the original document hash value according to the electronic document from the document deposit terminal 13 and the specific hash function, generate the issued document according to the private key and the original document hash value and write into the blockchain, wherein the blockchain records the original document hash value, the blockchain account and the written time-stamp to generate the corresponding blockchain transaction number.

Step S43: Bind the original document hash value, by the management interface 11, to the blockchain transaction number, and store the original document hash value and the blockchain transaction number in the database 111.

Step S44: Receive the electronic document, the document verification terminal 15.

Step S45: Generate the to-be-checked document hash value, by the document verification terminal 15, according to the electronic document and the specific hash function.

The document deposit terminal 13 is configured to transmit the electronic document to the corresponding document recipient terminal 14, which transmits the electronic document to the document verification terminal 15. After the document verification terminal receives the electronic document, the document verification terminal 15 generates the to-be-checked document hash value according to the electronic document and the specific hash function. In addition, the specific hash function utilized by the document deposit terminal 13 is identical to the document verification terminal 15.

Step S46: Submit the to-be-checked document hash value, by the document verification terminal 15, to the management interface.

Step S47: Obtain the blockchain transaction number bond to the original document hash value, by the management interface 11.

Since the management interface 11 is configured to receive the original document hash value and the blockchain transaction number and store the original document hash value and the blockchain transaction number into the database 111, and the management interface 11 is configured to obtain the original document hash value according to the to-be-checked document hash value from the database 111 after the management interface 11 receives the to-be-checked document hash value, wherein the original document hash value is bond to the blockchain transaction number, and the management interface 11 obtains the corresponding blockchain transaction number.

Step S48: Obtain the original document hash value and the blockchain account, by the management interface, according to the record of the blockchain corresponding to the blockchain transaction number, and submit the original document hash value and the blockchain account to the document verification terminal 15.

Step S49: Compare the to-be-checked document hash value and the original document hash value, by the document verification terminal 15, and verify the ID of the document deposit terminal 13.

When the to-be-checked document hash value is identical to the original document hash value, the electronic document provided by the document recipient terminal 14 is identical to the original document generated by the document deposit terminal 13.

The ways to verify the ID of document deposit terminal 13 are as follows. In an example, when the to-be-checked document hash value is identical to the original document hash value, the document verification terminal 15 compares the blockchain account and the ID account, and then verifies the ID of the document deposit terminal 13. In another example, the document deposit terminal 13 may provide the blockchain account and the ID information of the document deposit terminal to the management interface 11, the management interface 11 is configured to bind the ID information of the document deposit terminal to the blockchain account as the ID account and then store the ID account into the database 111. In addition, the management interface 11 may further include a data confirmation interface 112. In an embodiment, when the to-be-checked document hash value is identical to the original document hash value, the document verification terminal 15 may input the blockchain account or simultaneously input the blockchain account and the ID information of the document deposit terminal 13 into the data confirmation interface 112, such that the management interface 11 may compare the ID account to verify the ID account of the document deposit terminal 13 to generate a comparison result, wherein the ID account is stored in the database 111. The comparison result may be transmitted to the document verification terminal 15 for verifying the ID of the document deposit terminal 13. The ID information of the document deposit terminal 13 or the comparison result may be displayed on the data confirmation interface 112. For example, the document verification terminal 15 receives an electronic degree certification of “A” University from a graduate, if the hash value and the original document hash value of corresponding blockchain of the electronic degree certification are identical, the electronic degree certification is not tampered. And the document verification terminal 15 may look up the public blockchain account on the official website of the “A” University, and the degree certification is acknowledged as authentic when the comparison result is consistent. In an alternative embodiment, a tenant receives an electronic lease contract from a house landlord, if a hash value of the electronic lease contract is identical to an original document hash value of corresponding blockchain record, the ID information of the blockchain account is replied when the tenant inputs the blockchain account corresponding to the blockchain record into a confirmation interface. In another embodiment, the tenant may input the blockchain account corresponding to the blockchain record and an ID number of the house landlord for verification. As such, a verification system for electronic documents is not necessary to the document deposit terminal 13 to avoid leaking personal information and to provide the blockchain to the document verification terminal 15 for verifying whether the electronic document of the document deposit terminal 13 is identical to the original document and verifying the ID of the document deposit terminal 13. In addition, the management interface 11 may further bind the data to the account to increase a speed of comparison, which is more economic, avoids leaking personal information, is of higher credibility and more efficient than the prior arts.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A universal electronic document verification system with blockchain, comprising:
a management interface, configured to connect at least a blockchain;
a document deposit terminal, configured to generate a private key and a blockchain account corresponding to the private key, configured to make public an identification (ID) account having the blockchain account and an ID information of document deposit terminal corresponding to the blockchain account, and to generate an original document hash value according to a specific hash function and an electronic document, so as to generate an issued document according to the private key and the original document hash value, wherein the issued document is written into a blockchain of the at least a blockchain to record the original document hash value, the blockchain account and a written time-stamp to generate a corresponding blockchain transaction number; and
a document verification terminal, configured to receive the electronic document and the corresponding blockchain transaction number to generate a to-be-checked document hash value according to the specific hash function and the electronic document and to submit the blockchain transaction number to the management interface;
wherein the management interface is configured to obtain and submit the original document hash value and the blockchain account from the blockchain to the document verification terminal for verifying the to-be-checked document hash value with the original document hash value recorded in the blockchain and determining the blockchain account and the ID account.

2. The universal electronic document verification system with block chain of claim 1, wherein the document deposit terminal is configured to make public the ID account via an official website, a governmental website, a guild website or a third party impartial unit website.

3. The universal electronic document verification system with block chain of claim 2, wherein the management interface is configured to bind the original document hash value to the corresponding blockchain transaction number and store in a database.

4. The universal electronic document verification system with block chain of claim 3, wherein the document verification terminal is configured to receive the electronic document to generate the to-be-checked document hash value according to the specific hash function and the electronic document so as to submit the to-be-checked document hash value to the management interface, and the management interface is configured to obtain the corresponding blockchain transaction number from the database according to the to-be-checked document hash value, and the management interface is configured to submit the corresponding blockchain transaction number, the original document hash value and the blockchain account from the blockchain to the document verification terminal for verifying the to-be-checked document hash value with the original document hash value recorded by the blockchain and determining the blockchain account and the ID account.

5. The universal electronic document verification system with block chain of claim 4, wherein the management interface is configured to receive the electronic document to provide the electronic document to the document verification terminal.

6. The universal electronic document verification system with block chain of claim 1, wherein the management interface is configured to compare the blockchain account and the ID account of the document deposit terminal to determine a comparison result and provide the comparison result to the document verification terminal.

7. The universal electronic document verification system with block chain of claim 1, wherein the management interface is configured to monitor the ID account and trigger a warning when the ID account is modified.

8. A universal electronic document verification method with block chain, comprising:
connecting at least a blockchain of a management interface;
generating a private key and a blockchain account corresponding to the private key, and making public an identification (ID) account having the blockchain account and an ID information of a document deposit terminal corresponding to the blockchain account;
generating an original document hash value according to a specific hash function and an electronic document, so as to generate an issued document according to the private key and the original document hash value, wherein the issued document is written into a blockchain of the at least a blockchain to record the original document hash value, the blockchain account and a written time-stamp to generate a corresponding blockchain transaction number;
receiving the electronic document and the corresponding blockchain transaction number, by a document verification terminal, to generate a to-be-checked document hash value according to the specific hash function and the electronic document and to submit the blockchain transaction number to the management interface; and
obtaining and submitting the original document hash value and the blockchain account from the blockchain, by the management interface, to the document verification terminal for verifying the to-be-checked document hash value with the original document hash value recorded in the blockchain and determining the blockchain account and the ID account.

9. The universal electronic document verification method with block chain of claim 8, wherein the document deposit terminal is configured to make public the ID account via an official website, a governmental website, a guild website or a third party impartial unit website.

10. The universal electronic document verification method with block chain of claim 9, wherein the management interface is configured to bind the original document hash value to the corresponding blockchain transaction number and store in a database.

11. The universal electronic document verification method with block chain of claim 10, wherein the document verification terminal is configured to receive the electronic document to generate the to-be-checked document hash value according to the specific hash function and the electronic document so as to submit the to-be-checked document hash value to the management interface, and the management interface obtains the corresponding blockchain transaction number from the database according to the to-be-checked document hash value, and the management interface submits the corresponding blockchain transaction number, the original document hash value and the blockchain account from the blockchain to the document verification terminal for verifying the to-be-checked document hash value with the original document hash value recorded by the blockchain and determining the blockchain account and the ID account.

12. The universal electronic document verification method with block chain of claim 11, wherein the management interface is configured to receive the electronic document to provide the electronic document to the document verification terminal.

13. The universal electronic document verification method with block chain of claim 8, wherein the management interface is configured to compare the blockchain account and the ID account of the document deposit terminal to determine a comparison result and provide the comparison result to the document verification terminal.

14. The universal electronic document verification method with block chain of claim 8, wherein the management interface is configured to monitor the ID account and trigger a warning when the ID account is modified.
